(19) United States
(12) Patent Application Publication
(10) Pub. No.: US 2026/0352655 A1
(43) Pub. Date: Nov. 5, 2026

(54) INFORMATION PROCESSING SYSTEM, INFORMATION PROCESSING METHOD, AND COMPUTER READABLE MEDIUM

(71) Applicant: Ritsuko NAKAHIRA

(72) Inventor: Ritsuko NAKAHIRA

(21) Appl. No.: 19/124,446

(22) PCT Filed: Dec. 1, 2022
(86) PCT No.: PCT/JP2022/044370

§ 371 Date: Apr. 25, 2025

(51) Int. Cl. H04L 9/40

(52) U.S. Cl. CPC H04L 63/0861

(57) ABSTRACT

An information processing system (10) including: a generation unit (11) configured to generate, in a case where authentication based on first biometric information recorded in an identity verification medium and second biometric information of a user acquired by a sensor of a user terminal has been successfully performed, specific information based on the information recorded in the identity verification medium; and a control unit (12) configured to associate the specific information with account information of the user in a specific service and cause a distributed ledger system to record the associated information is provided.

### TECHNICAL FIELD

The present disclosure relates to an information processing system, an information processing method, and a computer readable medium.

### BACKGROUND ART

Patent Literature 1 discloses a technology for performing authentication based on a moving image captured by a camera and a face image included in identification information read from an IC chip built in a driver's license.

### CITATION LIST

### Patent Literature

[Patent Literature 1] Japanese Unexamined Patent Application Publication No. 2020-064541

### SUMMARY OF INVENTION

### Technical Problem

However, the technology disclosed in Patent Literature 1 has a problem that the convenience of authentication may not be sufficient since, for example, it is necessary to read a face image from a driver's license each time authentication is performed.

In view of the above-described problem, an object of the present disclosure is to provide a technology for improving the convenience of authentication.

### Solution to Problem

In a first example aspect of the present disclosure, an information processing system including: a generation unit configured to generate, in a case where authentication based on first biometric information recorded in an identity verification medium and second biometric information of a user acquired by a sensor of a user terminal has been successfully performed, specific information based on the information recorded in the identity verification medium; and a control unit configured to associate the specific information with account information of the user in a specific service and cause a distributed ledger system to record the associated information is provided.

Further, in a second example aspect of the present disclosure, an information processing method including: generating, in a case where authentication based on first biometric information recorded in an identity verification medium and second biometric information of a user acquired by a sensor of a user terminal has been successfully performed, specific information based on the information recorded in the identity verification medium; and associating the specific information with account information of the user in a specific service and causing a distributed ledger system to record the associated information is provided.

Further, in a third example aspect of the present disclosure, a non-transitory computer readable medium storing a program for causing a computer to: generate, in a case where authentication based on first biometric information recorded in an identity verification medium and second biometric information of a user acquired by a sensor of a user terminal has been successfully performed, specific information based on the information recorded in the identity verification medium; and associate the specific information with account information of the user in a specific service and cause a distributed ledger system to record the associated information is provided.

### Advantageous Effects of Invention

According to one example aspect, the convenience of authentication can be improved.

### BRIEF DESCRIPTION OF DRAWINGS

FIG. 1 is a diagram showing an example of a configuration of an information processing system according to an example embodiment;

FIG. 2 is a diagram showing an example of a system configuration of a communication system according to an example embodiment;

FIG. 3 is a diagram showing an example of a hardware configuration of each of a user terminal and servers according to an example embodiment;

FIG. 4 is a flowchart showing an example of processes performed by the communication system according to an example embodiment;

FIG. 5 is a diagram showing an example of a user DB according to the example embodiment;

FIG. 6 is a diagram showing an example of a display screen of a virtual space according to the example embodiment; and

FIG. 7 is a diagram showing an example of a display screen of a virtual space according to an example embodiment.

### EXAMPLE EMBODIMENT

The principle of the present disclosure will be described with reference to some illustrative example embodiments. It should be understood that these example embodiments are described for illustrative purposes only and will assist those skilled in the art in understanding and implementing the present disclosure without suggesting any limitations with regard to the scope of the present disclosure. The disclosure described herein may be implemented in a variety of ways other than those described below.

In the following description and claims, unless otherwise defined, the meanings of all technical and scientific terms used herein are the same as those generally understood by those skilled in the art to which the present disclosure pertains.

Example embodiments of the present disclosure will be described hereinafter with reference to the drawings.

### First Example Embodiment

### <Configuration>

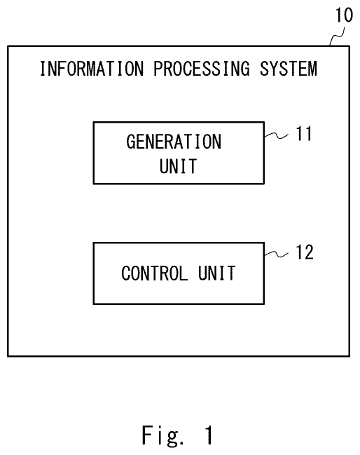

A configuration of an information processing system 10 according to an example embodiment will be described with reference to FIG. 1. FIG. 1 is a diagram showing an example of the configuration of the information processing system 10 according to the example embodiment. The information processing system 10 includes a generation unit 11 and a control unit 12. These units may be implemented by one or more programs installed in the information processing system 10 and hardware of the information processing system 10 such as a processor 101 and a memory 102 operating in cooperation with each other.

In a case where authentication based on first biometric information recorded in an identity verification medium and second biometric information of a user acquired by a sensor of a user terminal has been successfully performed, the generation unit 11 generates specific information based on the information recorded in the identity verification medium.

The control unit 12 associates the specific information with account information of the user in a specific service and causes a distributed ledger system to record the associated information.

### Second Example Embodiment

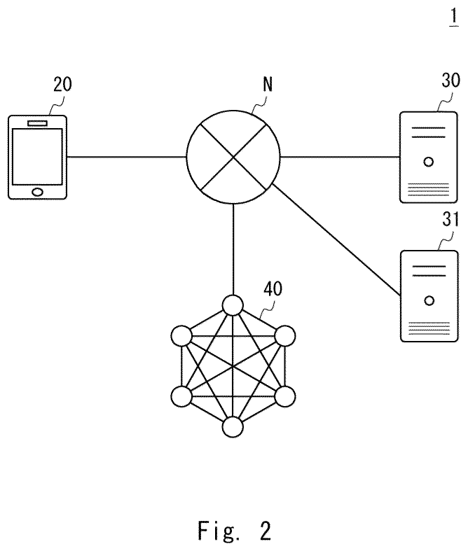

Next, a system configuration of a communication system 1 according to an example embodiment will be described with reference to FIG. 2.

### <System Configuration>

FIG. 2 is a diagram showing an example of a system configuration of the communication system 1 according to the example embodiment. In the example of FIG. 2, the communication system 1 includes a user terminal 20, a server 30, a server 31, and a blockchain system (an example of a “distributed ledger system”) 40. Note that at least one of the user terminal 20, the server 30, and the server 31 is an example of the information processing system 10. Note that the number of the user terminals 20, the number of the servers 30, the number of the servers 31, and the number of the blockchain systems 40 are not limited to those shown in the example of FIG. 2.

In the example of FIG. 2, the user terminal 20, the server 30, the server 31, and the blockchain system 40 are connected to each other so that they can communicate with each other through a network N.

Examples of the network N include, for example, the Internet, a mobile communication system, a wireless Local Area Network (LAN), a LAN, and a bus. Examples of the mobile communication system include, for example, a fifth-generation mobile communication system (5G), a sixth-generation mobile communication system (6G, Beyond 5G), a fourth-generation mobile communication system (4G), and a third-generation mobile communication system (3G).

The user terminal 20 may be, for example, an apparatus such as a smartphone, a tablet terminal, or a personal computer used by a user. For example, an application (a program) provided by a business operator or the like that operates the server 30 may be installed in the user terminal 20.

The servers 30 and 31 may be, for example, on-premise or cloud servers (computers). The server 30 provides an authentication (identity verification) service based on an identity verification card or the like issued by a public institution. Further, the server 30 may provide, for example, a metaverse service, which is an online virtual space, to a user. The server 31 provides a service (e.g., an administrative service) provided by another business operator that cooperates with the business operator that operates the server 30. The server 31 may be, for example, a server operated by a public institution such as an administrative institution and provides various services such as an administrative service to a user.

The blockchain system 40 is a system that records, in each node, a blockchain (an example of a “distributed ledger”), which is a list of records (blocks) linked using cryptographic technology. Note that the blockchain system 40 may be a public type blockchain system in which each node that records the list is not authenticated, or a private type blockchain system in which each node that records the list is authenticated.

The blockchain system 40 records a list of records (blocks) including a token ID and a Certified Person Token (CPT) (an example of “specific information”). The token ID is information indicating a location (an address, a block in the list) on the blockchain in which the certified person token is recorded. The token ID may be an identifier (a transaction ID, a transaction hash) of a transaction that causes the blockchain system 40 to record the certified person token. The certified person token may include, for example, a hash value of each information recorded in an identity verification medium. Note that the certified person token may be generated, for example, by at least one of the user terminal 20 and the server 30.

### <Hardware Configuration>

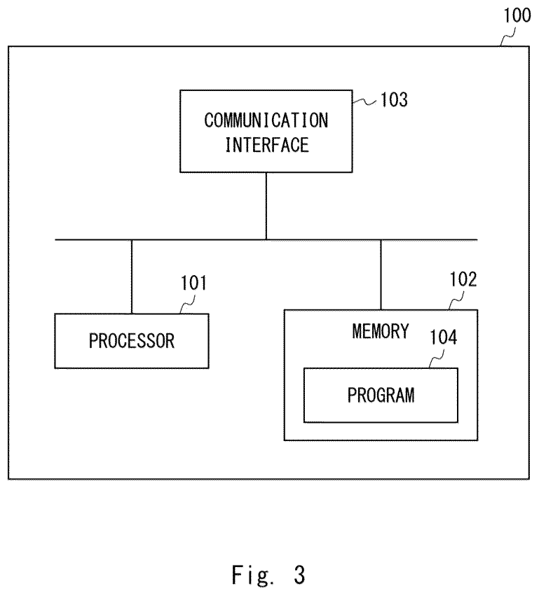

FIG. 3 is a diagram showing an example of a hardware configuration of each of the user terminal 20, the server 30, and the server 31 according to an example embodiment. In the following description, the user terminal 20 will be described as an example, and the hardware configuration of each of the servers 30 and 31 may be similar to that of the user terminal 20. In the example of FIG. 3, a computer 100 of the user terminal 20 includes the processor 101, the memory 102, and a communication interface 103. These components may be connected to each other by a bus or the like. The memory 102 stores at least a part of a program 104. The communication interface 103 includes interfaces required for communication with other network elements.

After the program 104 is executed by the processor 101, the memory 102, and the like in cooperation with each other, at least some of the processes in the example embodiments of the present disclosure are performed by the computer 100. The memory 102 may be of any type. The memory 102 may, as a non-limiting example, be a non-transitory computer readable storage medium. Further, the memory 102 may be implemented using any suitable data storage technology, such as a semiconductor-based memory device, a magnetic memory device and system, an optical memory device and system, a fixed memory, and a removable memory. Although only one memory 102 is shown in the computer 100, the computer 100 may include several memory modules that are physically different from each other. The processor 101 may be of any type. The processor 101 may include one or more of a general-purpose computer, a dedicated computer, a microprocessor, a Digital Signal Processor (DSP), and a processor based on a multi-core processor architecture as a non-limiting example. The computer 100 may include a plurality of processors, such as an application-specific integrated circuit chip that is temporally dependent on a clock that synchronizes the main processor.

The example embodiments of the present disclosure may be implemented in hardware or a dedicated circuit, software, logic, or any combination thereof. Some example aspects may be implemented in hardware, while other example aspects may be implemented in firmware or software that may be executed by a controller, a microprocessor, or other computing devices.

The present disclosure also provides at least one computer program product that is tangibly stored in a non-transitory computer readable storage medium. The computer program product includes computer executable instructions, such as instructions included in program modules, and is executed on a device on a target real or virtual processor to perform the processes or the method according to the present disclosure. The program modules include routines, programs, libraries, objects, classes, components, data structures, and the like that perform specific tasks or implement specific abstract data types. The functions of the program modules may be combined or divided among the program modules as desired in various example embodiments. Machine executable instructions for the program modules can be executed in a local or a distributed device. In a distributed device, program modules can be located in both local and remote storage media.

Program codes for performing the method according to the present disclosure may be written in any combination of one or more programming languages. These program codes are provided to a processor or a controller of a general-purpose computer, a dedicated computer, or other programmable data processing apparatuses. After the program codes are executed by the processor or the controller, functions/operations in the flowchart and/or a block diagram to be implemented are executed. The program codes are executed entirely on a machine, partly on a machine, as a stand-alone software package, partly on a machine, partly on a remote machine, or entirely on a remote machine or a server.

The program can be stored and provided to a computer using any type of non-transitory computer readable media. Non-transitory computer readable media include any type of tangible storage media. Examples of non-transitory computer readable media include magnetic storage media, optical magnetic storage media, optical disc media, semiconductor memories, and the like. Magnetic storage media include, for example, flexible disks, magnetic tapes, hard disk drives, and the like. Optical magnetic storage media include, for example, magneto-optical disks and the like. Optical disk media include, for example, a Blu-ray disc, a Compact Disc (CD)-Read Only Memory (ROM), a CD-Recordable (R), a CD-ReWritable (RW), and the like. Semiconductor memories include, for example, a solid state drive, a mask ROM, a Programmable ROM (PROM), an Erasable PROM (EPROM), a flash ROM, a random access memory (RAM), and the like. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

### <Processing>

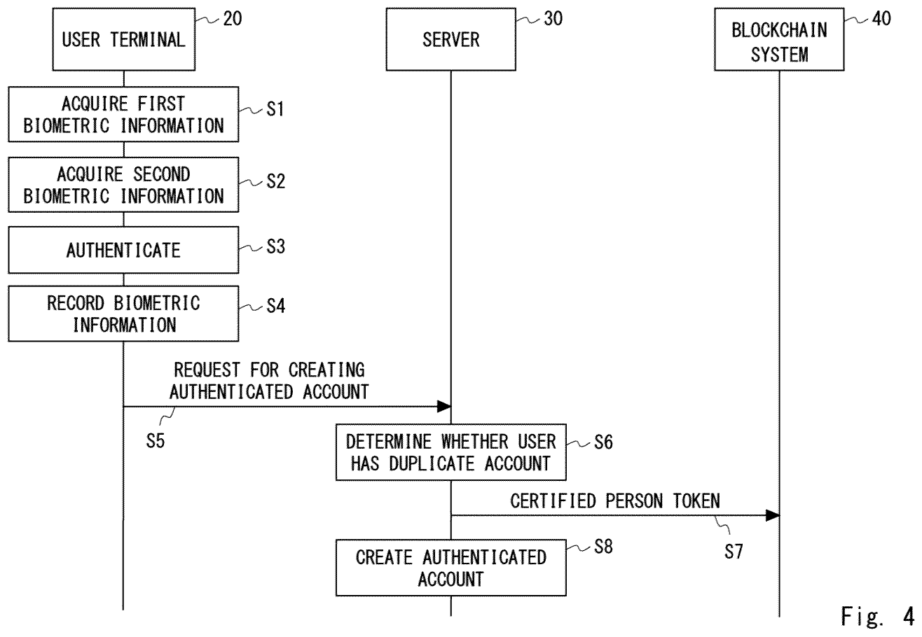

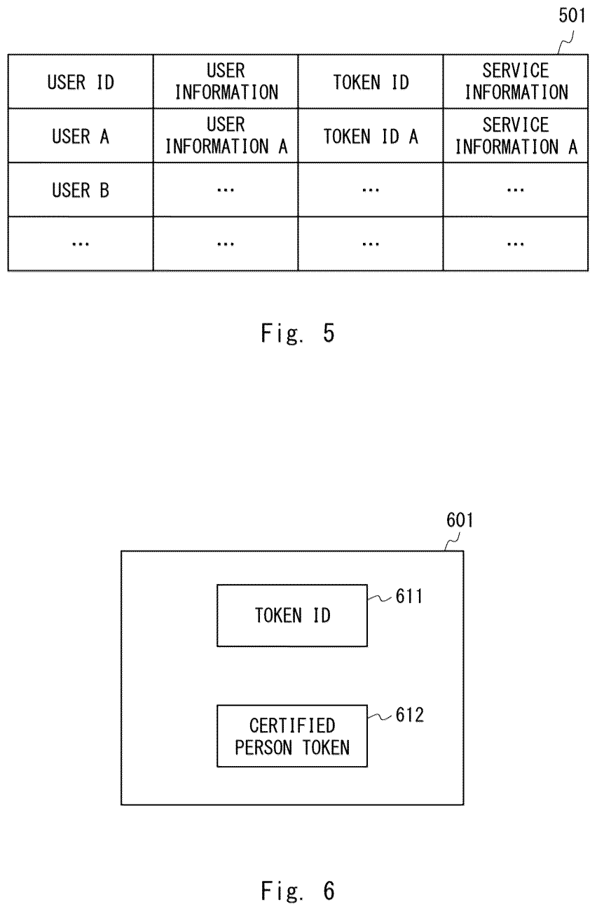

Next, an example of processes performed by the communication system 1 according to an example embodiment will be described with reference to FIGS. 4 to 6. FIG. 4 is a sequence diagram showing the example of processes performed by the communication system 1 according to the example embodiment. FIG. 5 is a diagram showing an example of a user DB 501 according to the example embodiment. FIG. 6 is a diagram showing an example of data included in one record 601 included in the blockchain according to the example embodiment.

The following processes may be performed, for example, in a case where a user creates an authenticated account for a specific service. Note that communication between the user terminal 20 and the server 30 may be encrypted by an application installed in the user terminal 20.

In Step S1, the user terminal 20 acquires information such as biometric information (hereinafter also referred to as “first biometric information” as appropriate) recorded in an identity verification medium in response to an operation performed by a user. Note that the identity verification medium may be, for example, an Integrated Circuit (IC) chip provided in an identity verification card or the like issued by a public institution. Examples of the identity verification card or the like issued by a public institution may include, for example, an individual number card in which an individual number (My Number) is described, a driver's license indicating that driving of a mobile body is permitted, a residence card indicating that residence is permitted, or a passport. The user terminal 20 may acquire information from the identity verification medium by Near field communication (NFC) using, for example, a Personal Identification Number (PIN) input by a user.

The first biometric information may include, for example, at least one of a face image, a finger vein pattern, iris information, and fingerprint information. Further, the user terminal 20 may acquire, for example, the number for identifying a user, such as an individual number, a driver's license number, a residence card number, or a passport number, from the identity verification medium. Further, the user terminal 20 may acquire, for example, personal information of a user, such as the name, address, date of birth, and gender, from the identity verification medium.

Next, the user terminal 20 acquires biometric information (hereinafter also referred to as “second biometric information” as appropriate) of a user by a sensor of the user terminal 20 (Step S2). Note that the user terminal 20 may acquire, for example, an image (a still image or a moving image) of a face of a user captured by a camera of the user terminal 20. Further, the user terminal 20 may acquire, for example, a finger vein pattern by a dedicated sensor connected to the user terminal 20 or by a camera built in the user terminal 20. Further, the user terminal 20 may acquire, for example, iris information based on an image captured by the camera of the user terminal 20. Further, the user terminal 20 may acquire, for example, fingerprint information by a fingerprint sensor of the user terminal 20.

Next, the user terminal 20 authenticates (performs identity verification of) a user based on the first biometric information recorded in the identity verification medium and the second biometric information of the user acquired by the sensor of the user terminal (Step S3). Note that the user terminal 20 may calculate a degree of similarity between the first biometric information and the second biometric information by using, for example, Artificial Intelligence (AI), and may determine that authentication has been successfully performed if the calculated degree of similarity is equal to or greater than a threshold. Further, the user terminal 20 may determine that authentication has been successfully performed if a One Time Password (OTP) authentication has also been successfully performed. In this case, the server 30 may provide a one-time password to a user by an e-mail addressed to a user's e-mail address, a Short Message Service (SMS), or the like.

Next, the user terminal 20 causes a storage apparatus of the user terminal 20 to record at least one of the first biometric information and the second biometric information (Step S4). Note that, in a case where a user uses a specific service next time or after that (e.g., in a case where a user logs in), the user terminal 20 may authenticate the user based on at least one of the first biometric information and the second biometric information recorded in the user terminal 20 and third biometric information of the user acquired by the sensor of the user terminal 20. By doing so, for example, in a case where authentication of a user is performed in a specific service next time, it is possible to reduce the time and effort taken to cause the user terminal 20 to read data from the identity verification medium. Further, as compared to a configuration in which biometric information is held by the server 30 or the like, it is possible to reduce the possibility of biometric information of a user being leaked. Note that the user terminal 20 may encrypt the first biometric information and the second biometric information by using a specific encryption method and record the encrypted information. Further, the user terminal 20 may use biometric authentication (e.g., iris authentication and hearable authentication) which is highly compatible with a Virtual Reality (VR) goggle. In this case, the user terminal 20 may acquire, for example, an iris image and audio data for hearable authentication by a VR goggle and cause the storage apparatus of the user terminal 20 to record them. Further, in a case where a user uses a specific service next time or after that, an iris image and audio data for hearable authentication may be acquired by a VR goggle, and a user may be authenticated based on the acquired information and the recorded information.

Next, the user terminal 20 transmits a request for creating an authenticated account to the server 30 (Step S5). Note that the request for creating an authenticated account includes information indicating that the identity verification has been successfully performed and a user ID which is identification information of the account of a user in a specific service. The user ID may be, for example, an e-mail address of a user or the like specified by the user. Further, the request for creating an authenticated account may include information such as the number for identifying a user (e.g., the individual number), the name, address, date of birth, and gender acquired from the identity verification medium.

Next, the server 30 determines whether or not the user already has another authenticated account (a duplicate account) (Step S6). Note that in a case where a hash value based on the number for identifying a user (e.g., the individual number) or the like is already registered in the certified person token of the blockchain system 40, the server 30 may determine that the user already has another authenticated account. By doing so, as compared to a configuration in which the server 30 or the like holds personal information of a user to determine a duplicate account, it is possible to reduce the possibility of personal information of a user being leaked. In a case where the user already has another authenticated account, the server 30 may return a notification indicating that the user already has another authenticated account to the user terminal 20, and the process of Step S7 and the subsequent processes may not be performed.

Further, in a case where the number for identifying a user and the like included in the received request for creating an authenticated account are already registered in the user DB 501, the server 30 may determine that the user already has another authenticated account.

In the example of FIG. 5, user information, a token ID, and service information are associated with a user ID and recorded in the user DB 501. The user information may include information such as the number for identifying a user (e.g., the individual number), the name, address, date of birth, and gender. The service information is user data used in various services provided by the server 30. The service information may include, for example, information about an avatar of a user.

In a case where a user has no other authenticated account, the server 30 causes the blockchain system 40 to record the certified person token (Step S7). Thus, as shown in FIG. 6, the record 601 including the token ID and the certified person token is added to the blockchain.

Note that the server 30 may cause the blockchain system 40 specified by a user from among a plurality of blockchain systems to record the certified person token. By doing so, a user can use the desired blockchain system in a case where, for example, transaction fees, security levels, and the like differ for each blockchain system.

Next, the server 30 creates an authenticated account for a user (Step S8). Note that the server 30 may record a record of a combination of the user ID, the user information, and the token ID in the user DB 501. By doing so, the certified person token and account information of the user are associated with each other and recorded.

### Example in Which the Certified Person Token is Used in Another Service

The server 31 may use the certified person token recorded in the blockchain system 40. Thus, by performing identity verification in a specific service provided by the server 30, a user can perform identity verification in another service (e.g., an administrative service, a financial service, a payment service, a securities service, and an insurance service) without having to perform an operation for causing the user terminal 20 to read data from the identity verification medium.

In this case, if, for example, an authentication service request is started by a person in charge of the service, the server 31 may transmit a biometric authentication request to the user terminal 20 for performing identity verification of a user. Further, in a case where the server 31 receives information such as the name, address, date of birth, and gender input by a user from the user terminal 20, the server 31 may transmit a biometric authentication request for performing identity verification of the user to the user terminal 20.

Then the user terminal 20 may perform authentication based on the first biometric information recorded in the user terminal 20 and the second biometric information acquired by the camera or the like of the user terminal 20. Then the user terminal 20 may return a result of the authentication and the user ID to the server 31.

Then the server 31 may acquire the token ID associated with the user ID from the user DB 501. Then the server 31 may calculate a hash value of each piece of information such as the name, address, date of birth, gender, and the like input by a user. Then, if the calculated hash values match the hash values included in the certified person token associated with the token ID and recorded in the blockchain system 40, the server 31 may determine that identity verification has been successfully performed. Thus, for example, the possibility of accounts of an administrative service and the like being taken over can be reduced.

Further, the server 31 may determine whether or not the user already has another authenticated account (a duplicate account). In this case, the server 31 may determine the nationality of the user based on information acquired from the user DB 501, and if the user is a foreign national, the server 31 may acquire information for identifying the user, for example, by making inquiries to a server of the Ministry of Foreign Affairs etc. Further, if the user is not a foreign national, the server 31 may determine whether or not the user already has another authenticated account based on the number (e.g., the individual number) for identifying the user managed by the server 31. In this case, the server 31 may record, for example, information indicating whether or not an authenticated account is present for each individual number. Note that the server 31 may record the certified person token of each user in an internal database or the like in synchronization with the blockchain system 40, and may make determination based on the information recorded in the database or the like instead of the blockchain system 40.

### Example in Which Data About Identity Verification is Used in a Virtual Space

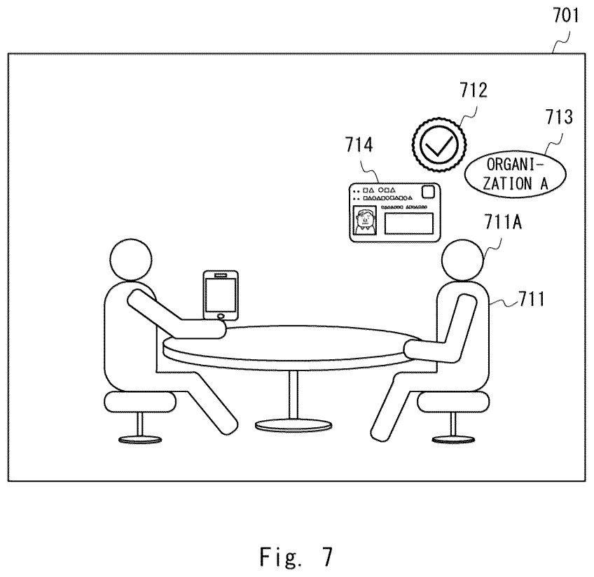

Next, an example in which data about identity verification is used in a virtual space will be described with reference to FIG. 7. FIG. 7 is a diagram showing an example of a display screen of a virtual space according to an example embodiment.

The server 30 may associate information indicating that a user is authenticated based on the identity verification medium on a virtual space (e.g., a metaverse) in a specific service with an avatar of the user and display it. By doing so, for example, a person in charge (e.g., a sales representative or a contact person at a public institution) who deals with a user on the metaverse can know that the user is a user whose identity has been verified. In this case, the server 30 determines whether or not the certified person token corresponding to the user is recorded in the blockchain system 40, and if the server 30 determines that it is recorded, the server 30 may associate a specific display object with the avatar of the user and display it.

In the example of FIG. 7, a display object 712 indicating that a user is authenticated based on the identity verification medium is associated with an avatar 711 of the user and displayed on a display screen 701 for displaying the virtual space in a specific service on a display.

Further, the server 30 may associate information corresponding to an attribute of the blockchain system 40 with the avatar of the user on the virtual space in a specific service. The attribute of the blockchain system 40 may include, for example, whether the blockchain system 40 is a system of a public type or a private type. Further, the attribute of the blockchain system 40 may include, for example, information about an organization (an entity) which operates the blockchain system 40.

Thus, for example, a person in charge or the like who deals with a user on the metaverse can know the attribute of the blockchain system 40 which records that the user is a user whose identity has been verified. Therefore, in a case where, for example, transaction fees, security levels, and the like differ for each blockchain system, a person in charge or the like who deals with a user can presume the degree of reliability of the user in accordance with the blockchain system 40 used by the user. In the example of FIG. 7, a display object 713 indicating the organization which operates the blockchain system 40 is associated with the avatar 711 of a user and displayed.

Further, the server 30 or the user terminal 20 may determine the avatar of the user in a specific service based on a face image included in the first biometric information. By doing so, for example, the person in charge or the like who deals with a user on the metaverse can roughly know the face of the user. Therefore, if a user comes to a shop or the like at a later date, the user can be identified.

In this case, the server 30 may associate information indicating that the avatar of a user has been determined based on the face image included in the first biometric information with the avatar of the user and display it on the virtual space in a specific service.

In the example of FIG. 7, a face 711A of the avatar 711 of a user is generated by AI or the like based on the face image recorded in the IC chip of the individual number card. Further, in the example of FIG. 7, a display object 714 indicating that the avatar of a user has been determined based on the face image included in the first biometric information is associated with the face 711A of the avatar 711 of the user and displayed.

The server 30 may associate information indicating the type (the category) of the identity verification medium used for authentication of a user with the avatar of the user and display it on the virtual space in a specific service. By doing so, for example, a person in charge or the like who deals with a user on the metaverse can know based on which of the individual number card, driver's license, residence card, passport, and the like the identity verification of the user has been performed. In this case, the server 30 may display a display object (e.g., an illustration of the individual number card) indicating the type of the identity verification medium used for authentication of a user as shown in the display object 714 of FIG. 7.

### <Modified Example>

The information processing system 10 may be implemented by the user terminal 20 according to the above-described example embodiments, the server 30 according to the above-described example embodiments, or both the user terminal 20 and the server 30.

The processes performed by the information processing system 10 may be performed by at least one of the user terminal 20, the server 30, the server 31, and the blockchain system 40. Note that, in a case where the processes are performed by the blockchain system 40, the processes may be performed by a smart contract that is a program stored in the blockchain system 40.

The information processing system 10 may be an apparatus included in one housing. However, the information processing system 10 according to the present disclosure is not limited thereto. Each component of the information processing system 10 may be implemented by, for example, cloud computing composed of one or more computers.

The information processing system 10 described above is also included in an example of the “information processing system” according to the present disclosure.

Note that the present disclosure is not limited to the above-described example embodiments and may be changed as appropriate without departing from the scope and spirit of the present disclosure.

The whole or part of the example embodiments disclosed above can be described as, but not limited to, the following supplementary notes.

### (Supplementary Note 1)

An information processing system comprising:
a generation unit configured to generate, in a case where authentication based on first biometric information recorded in an identity verification medium and second biometric information of a user acquired by a sensor of a user terminal has been successfully performed, specific information based on the information recorded in the identity verification medium; and
a control unit configured to associate the specific information with account information of the user in a specific service and cause a distributed ledger system to record the associated information.

### (Supplementary Note 2)

The information processing system according to supplementary note 1, wherein the identity verification medium is an individual number card in which an individual number is described, a driver's license indicating that driving of a mobile body is permitted, a residence card indicating that residence is permitted, or an Integrated Circuit (IC) chip of a passport.

### (Supplementary Note 3)

The information processing system according to supplementary note 1 or 2, wherein the first biometric information includes at least one of a face image, a finger vein pattern, iris information, and fingerprint information.

### (Supplementary Note 4)

The information processing system according to any one of supplementary notes 1 to 3, wherein in a case where the authentication based on the first biometric information and the second biometric information has been successfully performed, the control unit causes the user terminal to record at least one of the first biometric information and the second biometric information.

### (Supplementary Note 5)

The information processing system according to any one of supplementary notes 1 to 4, wherein in a case where the user who has been authenticated based on the identity verification medium uses the specific service, the control unit authenticates the user based on at least one of the first biometric information and the second biometric information recorded in the user terminal and third biometric information of the user acquired by the sensor of the user terminal.

### (Supplementary Note 6)

The information processing system according to any one of supplementary notes 1 to 5, wherein the control unit prohibits the user from creating a plurality of accounts in the specific service based on the specific information recorded in the distributed ledger system.

### (Supplementary Note 7)

The information processing system according to any one of supplementary notes 1 to 6, wherein the control unit associates information indicating that the user has been authenticated based on the identity verification medium with an avatar of the user and displays the associated information on a virtual space in the specific service.

### (Supplementary Note 8)

The information processing system according to any one of supplementary notes 1 to 7, wherein the control unit associates information corresponding to an attribute of the distributed ledger system with the avatar of the user and displays the associated information on the virtual space in the specific service.

### (Supplementary Note 9)

The information processing system according to any one of supplementary notes 1 to 8, wherein the control unit determines the avatar of the user in the specific service based on the face image included in the first biometric information.

### (Supplementary Note 10)

The information processing system according to supplementary note 9, wherein the control unit associates information indicating that the avatar has been determined based on the face image included in the first biometric information with the avatar and displays the associated information on the virtual space in the specific service.

### (Supplementary Note 11)

An information processing method comprising:
generating, in a case where authentication based on first biometric information recorded in an identity verification medium and second biometric information of a user acquired by a sensor of a user terminal has been successfully performed, specific information based on the information recorded in the identity verification medium; and
associating the specific information with account information of the user in a specific service and causing a distributed ledger system to record the associated information.

### (Supplementary Note 12)

A non-transitory computer readable medium storing a program for causing a computer to:
generate, in a case where authentication based on first biometric information recorded in an identity verification medium and second biometric information of a user acquired by a sensor of a user terminal has been successfully performed, specific information based on the information recorded in the identity verification medium; and
associate the specific information with account information of the user in a specific service and cause a distributed ledger system to record the associated information.

### REFERENCE SIGNS LIST

1 COMMUNICATION SYSTEM
10 INFORMATION PROCESSING SYSTEM
11 GENERATION UNIT
12 CONTROL UNIT
20 USER TERMINAL
30 SERVER
31 SERVER
40 BLOCKCHAIN SYSTEM

What is claimed is:

1. An information processing system comprising:
at least one memory storing instructions, and
at least one processor configured to execute the instructions to;
generate, in a case where authentication based on first biometric information recorded in an identity verification medium and second biometric information of a user acquired by a sensor of a user terminal has been successfully performed, specific information based on the information recorded in the identity verification medium; and
associate the specific information with account information of the user in a specific service and cause a distributed ledger system to record the associated information.

2. The information processing system according to claim 1, wherein the identity verification medium is an individual number card in which an individual number is described, a driver's license indicating that driving of a mobile body is permitted, a residence card indicating that residence is permitted, or an Integrated Circuit (IC) chip of a passport.

3. The information processing system according to claim 1, wherein the first biometric information includes at least one of a face image, a finger vein pattern, iris information, and fingerprint information.

4. The information processing system according to claim 1, wherein in a case where the authentication based on the first biometric information and the second biometric information has been successfully performed, the at least one processor configured to cause the user terminal to record at least one of the first biometric information and the second biometric information.

5. The information processing system according to claim 1, wherein in a case where the user who has been authenticated based on the identity verification medium uses the specific service, the at least one processor configured to authenticate the user based on at least one of the first biometric information and the second biometric information recorded in the user terminal and third biometric information of the user acquired by the sensor of the user terminal.

6. The information processing system according to claim 1, wherein the at least one processor configured to prohibit the user from creating a plurality of accounts in the specific service based on the specific information recorded in the distributed ledger system.

7. The information processing system according to claim 1, wherein the at least one processor configured to associate information indicating that the user has been authenticated based on the identity verification medium with an avatar of the user and displays the associated information on a virtual space in the specific service.

8. The information processing system according to claim 1, wherein the at least one processor configured to associate information corresponding to an attribute of the distributed ledger system with the avatar of the user and displays the associated information on the virtual space in the specific service.

9. The information processing system according to claim 1, wherein the at least one processor configured to determine the avatar of the user in the specific service based on the face image included in the first biometric information.

10. The information processing system according to claim 9, wherein the at least one processor configured to associate information indicating that the avatar has been determined based on the face image included in the first biometric information with the avatar and displays the associated information on the virtual space in the specific service.

11. An information processing method comprising:
generating, in a case where authentication based on first biometric information recorded in an identity verification medium and second biometric information of a user acquired by a sensor of a user terminal has been successfully performed, specific information based on the information recorded in the identity verification medium; and
associating the specific information with account information of the user in a specific service and causing a distributed ledger system to record the associated information.

12. A non-transitory computer readable medium storing a program for causing a computer to:
generate, in a case where authentication based on first biometric information recorded in an identity verification medium and second biometric information of a user acquired by a sensor of a user terminal has been successfully performed, specific information based on the information recorded in the identity verification medium; and
associate the specific information with account information of the user in a specific service and cause a distributed ledger system to record the associated information.
